(19) United States
(12) Patent Application Publication
(10) Pub. No.: US 2004/0258291 A1
(43) Pub. Date: Dec. 23, 2004

(54) Method and system for tracking abnormality data

(76) Inventor: Gregory A. Gustafson, Independence, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/871,763

(22) Filed: Jun. 17, 2004

Related U.S. Application Data
(60) Provisional application No. 60/480,496, filed on Jun. 20, 2003.

(51) Int. Cl. G06K 9/00

(52) U.S. Cl. 382/131

(57) ABSTRACT

A method of tracking abnormality data for use with a CAD system as part of or in conjunction with a mammography information system. The method of tracking abnormality data comprises the steps of obtaining a data form with at least a visual result reporting area, wherein the data form is associated with a particular patient. Visual results of a medical imaging procedure are obtained from a computer aided diagnostic system for the patient which are then transferred onto the visual result reporting area of the data form for the patient. A hard copy of the data form is generated which includes the visual results of the medical imaging procedure. The method further includes manually entering information into the diagnostic information reporting and tracking area of the data form for the patient and storing the completed data form in a medical information system.

### FIELD OF THE INVENTION

The invention relates to data management in medical applications, and more specifically to computer aided detection systems.

### BACKGROUND OF THE INVENTION

Historically, interpretation and diagnosis of mammograms and other organ analysis has been performed using hardcopy x-ray films viewed on an alternator, that typically allows x-ray films to be illuminated and masked to block out unwanted light, or newer technology that allows the mammograms to be viewed electronically on monitors. A radiologist views the images and dictates or uses a computerized mammography information system to simultaneously create narrative reports, track findings, or make recommendations associated with a study.

Computer aided detection software (CAD), which has recently become available, allows a radiologist to check his or her interpretation with the output created by the CAD system. CAD system output consists of electronic or a combination of paper and electronic output representing mammography images of a current study with an area or areas of interest, referred to as markers, superimposed on these images. Because a radiologist reviews these outputs, efficiency and accuracy would be improved by merging the CAD output and mammography tracking form, where a radiologist could indicate results and correlate the CAD and interpreter findings for authentication that can be electronically collected by using optical mark recognition (OMR). Correlated finding locations are collected by the interpreter selecting (marking) cells visible or not in grid format in or around the perimeter of images to indicate two-dimensional intersection on an individual image (x- and y-coordinates), and when combined with the complimentary breast view (z-coordinate), the three-dimensional location of an abnormality is then available to assist in tracking. Abnormalities are typically tracked by a clock and depth location or by a quadrant and depth location.

Additionally, the Mammography Quality Standards Act of 1992 (MQSA) and the Mammography Quality Standards Reauthorization Act of 1998 (MQRSA) have mandated that mammography facilities track positive mammography findings and correlate such findings with biopsy results, maintain statistics for mammography medical outcome and analysis audits on each physician, and provide direct written notification to all patients of their exam results in lay person's terms. Meeting these requirements is often accomplished by manually keeping records in a ledger and mailing pre-written form letters to the patient, or by using a computerized mammography information system, such as the PenRad Mammography Information System, to electronically track abnormalities, generate statistics, and provide patient correspondence. The manual tracking method usually involves an individual, other than the interpreting physician, reading the mammography report and then transferring the data to a ledger or an electronic file, such as Microsoft Excel. Often, the required statistics must be manually calculated. This method is tedious and time-consuming and creates the potential for incorrectly entered data.

### SUMMARY OF THE INVENTION

When interpreting mammograms with CAD systems and PACS, it is desirable to track an individual patient's results after each mammography procedure. Additionally, it would be beneficial to be able to quickly access that patient's file history, track information and changes associated with any abnormalities or areas of interest, and record radiologist observations, diagnoses and recommendations on a single document, without having to manipulate a large, multi-page hardcopy medical file. Because sophisticated electronic mammography information systems are not used in all facilities, there is a need in the industry to integrate such a document with visual CAD results, providing a complete summary of mammography-related information, data, and documentation for a patient in a format that provides for easy editing and review.

The invention relates to a method of capturing and reporting abnormality tracking data for use with a CAD system as part of or in conjunction with a mammography information system and substantially meets the aforementioned needs of the industry. In one example embodiment, the method of capturing and reporting abnormality tracking data comprises the steps of obtaining a data form with at least a visual result reporting area and a diagnostic information reporting and tracking area, wherein the data form is associated with a particular patient. Visual results of a medical imaging procedure are obtained from a computer aided diagnostic system for the patient which are then transferred to the visual result reporting area of the data form for the patient. A hard copy of the data form is generated which includes the visual results of the medical imaging procedure. The method further includes manually entering information into the diagnostic information reporting and tracking area of the data form for the patient and storing the completed data form in a medical information system.

In an example embodiment, the method of capturing and reporting abnormality tracking data of the invention may be used by a radiologist or other medical professional to document observations, findings, and recommendations, that may be quickly and easily added to a mammography information system, for example by scanning the document or manually transferring the information from the abnormality tracking checklist to the system.

The above summary of the invention is not intended to describe each illustrated embodiment or every implementation of the invention. The figure and the detailed description that follow more particularly exemplify these embodiments.

### BRIEF DESCRIPTION OF THE DRAWINGS

FIG. 1 is an example schematic of a data form for use with the invention.

FIG. 2 is an example embodiment of a data form for use with the method of the invention.

FIG. 3 is an alternate example embodiment of a data form for use with the method of the invention.

FIG. 4 is an alternate example embodiment of a data form for use with the method of the invention.

FIG. 5 is an alternate example embodiment of a data form for use with the method of the invention.

FIG. 6 is an example embodiment of a data form that includes an x-y axis on each visual result reporting area for use with the method of the invention.

FIG. 7 is a sample grid configuration for tracking abnormality locations on a data form for use with the method of the invention.

FIG. 8 is an illustration of the x, y, and z coordinates as used for plotting the clock and depth locations of abnormalities for use with the method of the invention.

FIGS. 9A-9G are examples of boundary and/or marking regions that are used for mark recognition and erasure.

FIG. 10 is an example of code used for mark recognition and erasure.

FIG. 11 is an example of code used for converting x and y coordinates into a clock location.

### DETAILED DESCRIPTION OF THE INVENTION

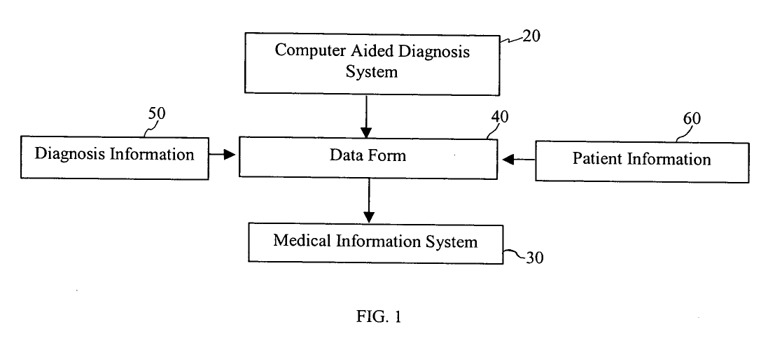

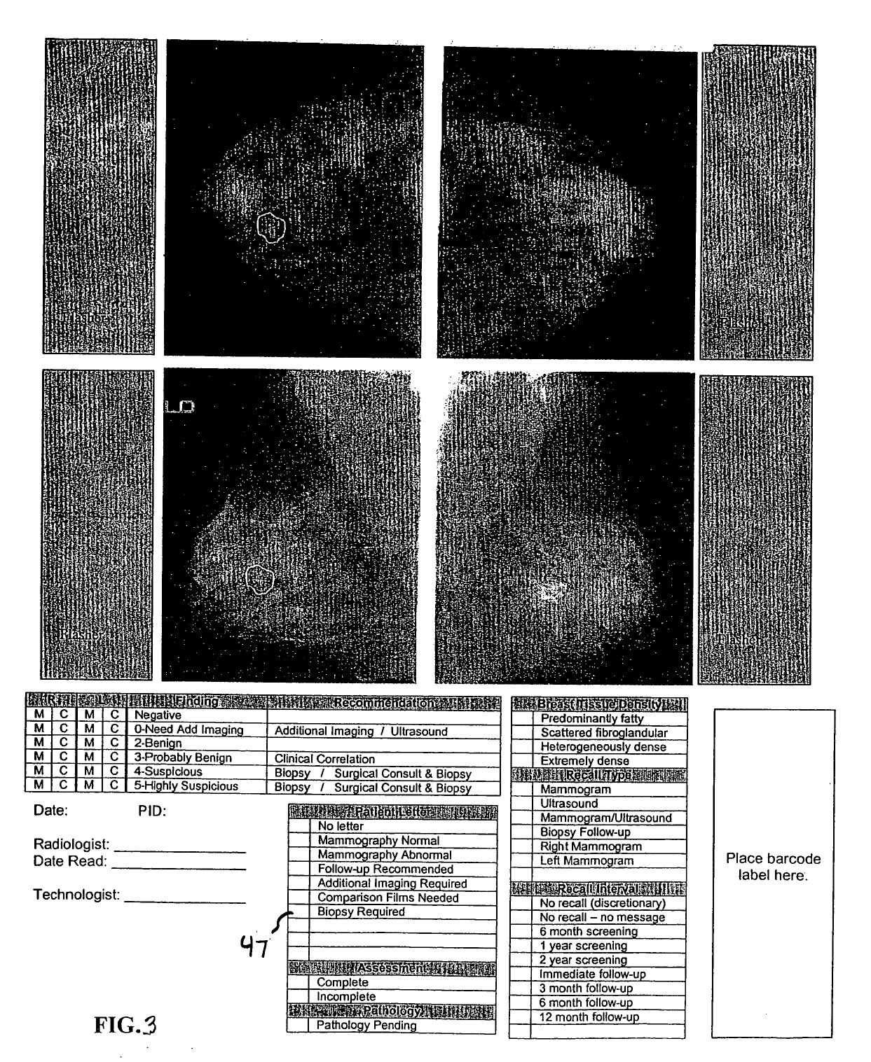

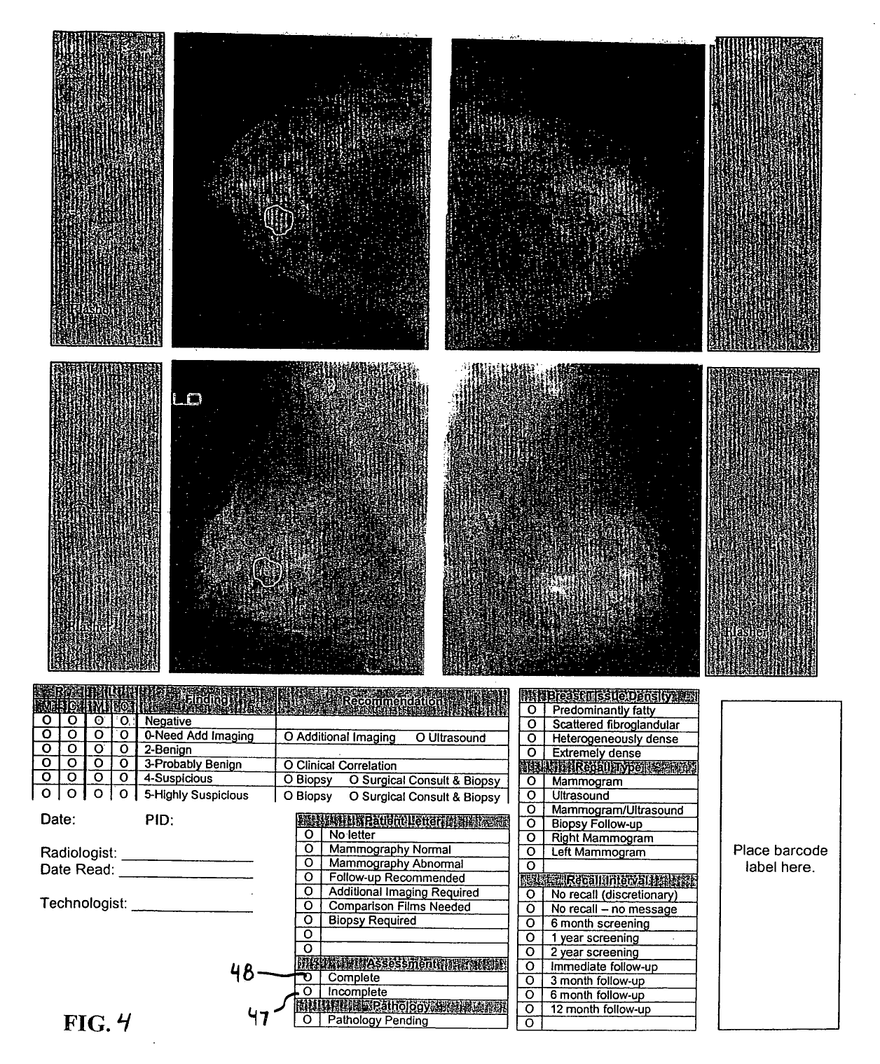

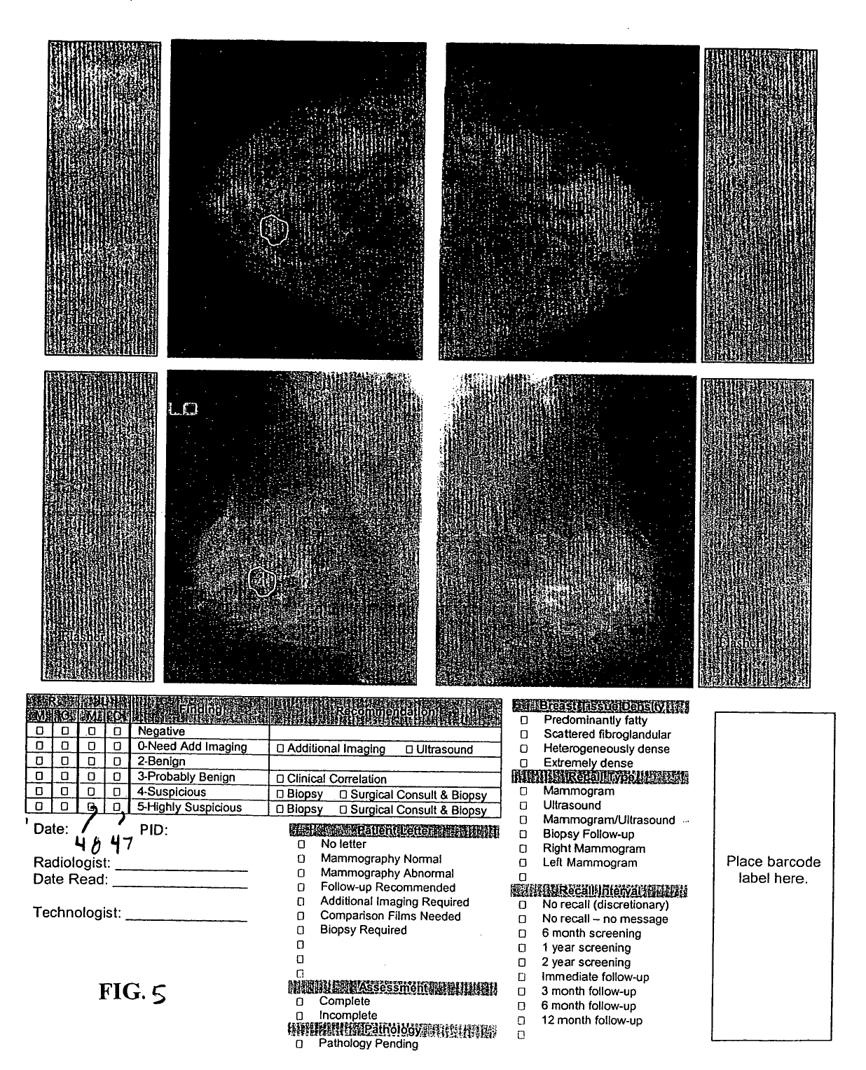

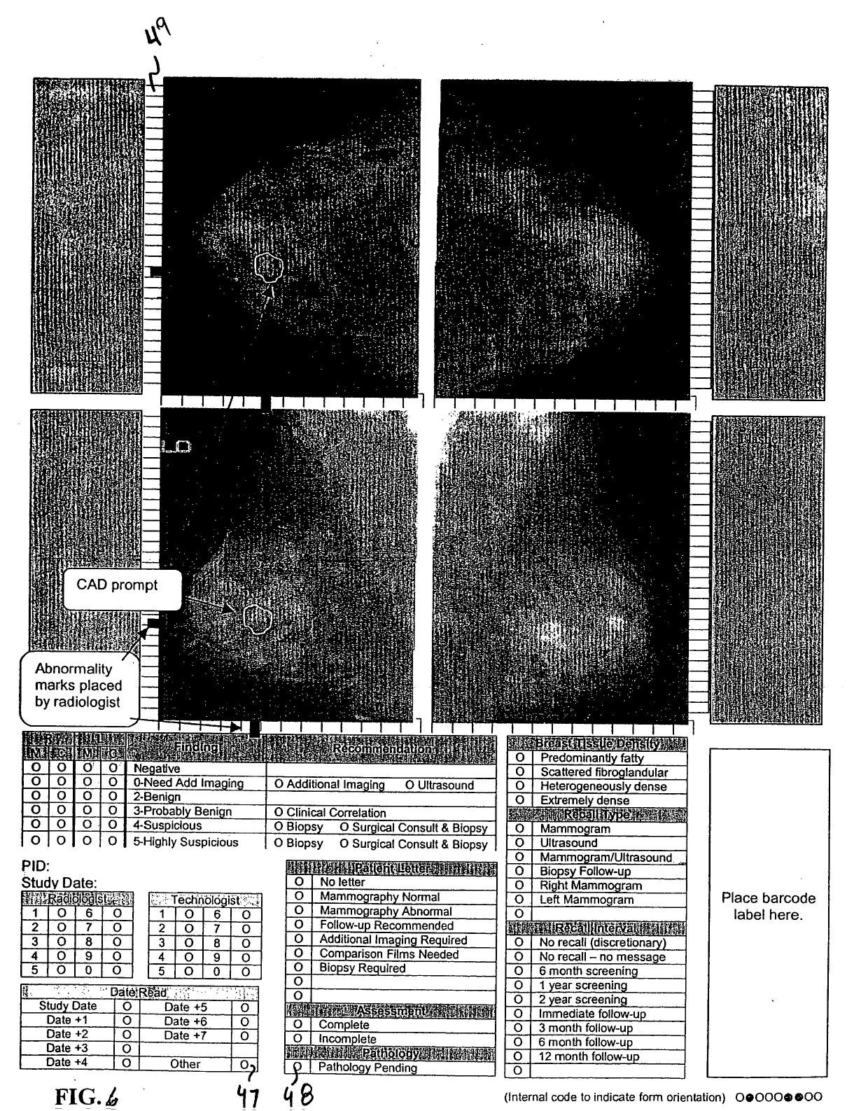

The method of the invention simplifies the process of capturing and reporting abnormality tracking data. As illustrated in FIG. 1, the method may use a computer aided diagnosis (CAD) system 20, for capturing mammography images, as part of a mammography or medical information system 30. The method may be more readily understood by reference to FIGS. 1-9 and the following description.

FIG. 1 is an example embodiment of the invention illustrating the interaction between the computer aided diagnosis system 20, a medical information system 30 and a data form 40. FIG. 1 also illustrates that diagnosis information 50 and patient information 60 may also be incorporated into the data form 40.

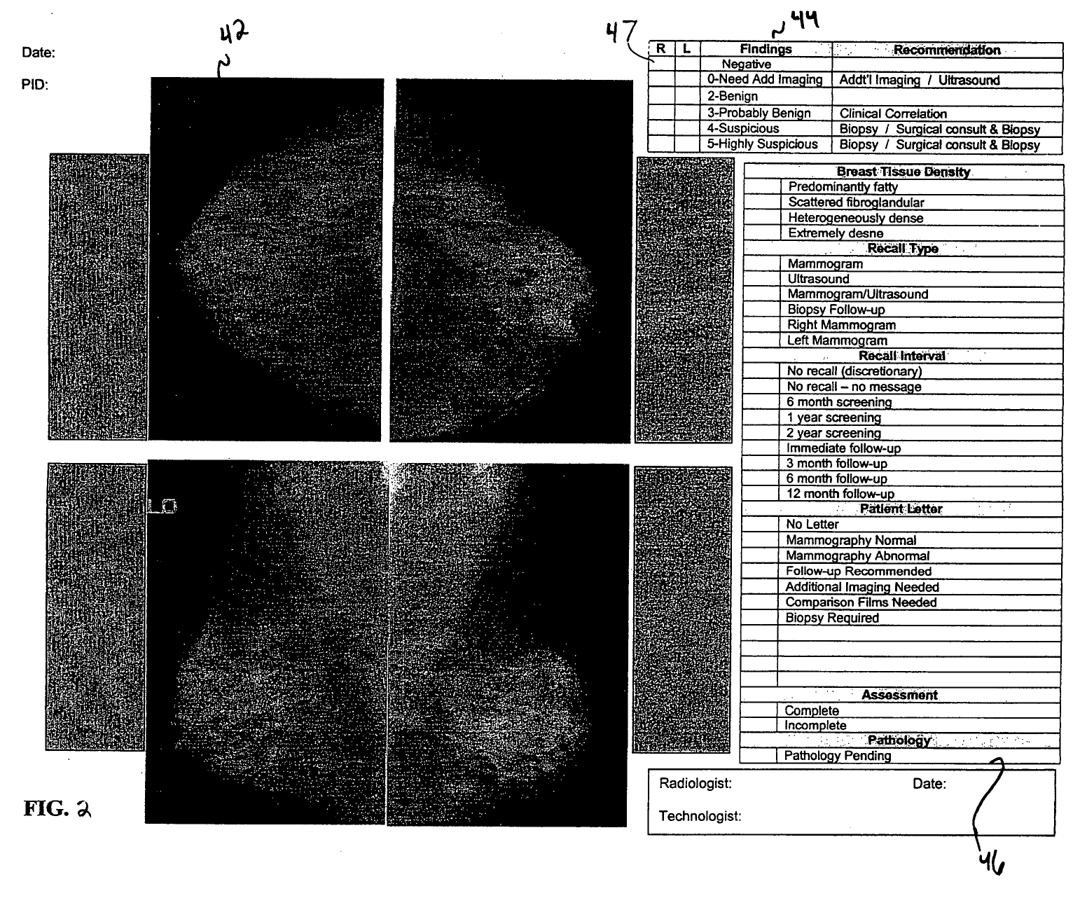

FIGS. 2-6 are example embodiments of a data form 40 for use with the method of the invention. In an example embodiment, each patient is assigned a data form 40 for tracking that patient's CAD results and diagnosis information 50. In this example embodiment, data form 40 comprises a visual result reporting area 42, a diagnostic information reporting area 44 and a tracking area 46. Selected visual results of a medical imaging procedure from a CAD system 20 for the patient are incorporated onto data form 40 in the visual results reporting area 42. For example, the visual results in FIGS. 2-6 are the four primary mammography views, but other medical images or visual results may be incorporated onto data form 40. Diagnostic information reporting area 44 and tracking area46 allows a radiologist or other medical professional to note their findings, recommendations, and other pertinent information on the same data form 40 as the visual results, providing a concise, accurate, and complete record of patient information associated with a particular procedure on a single form.

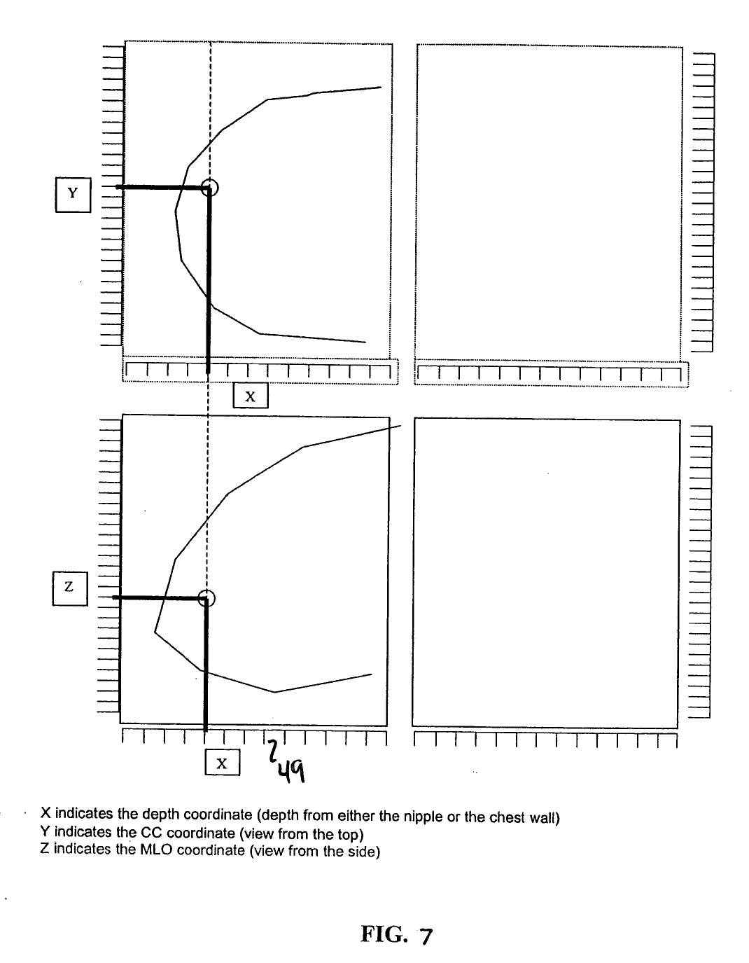

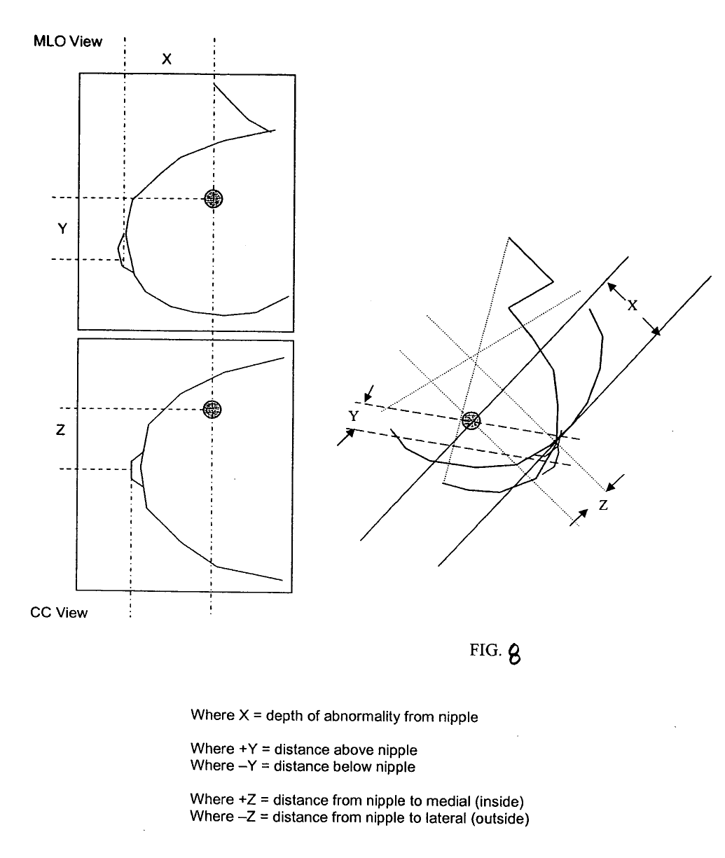

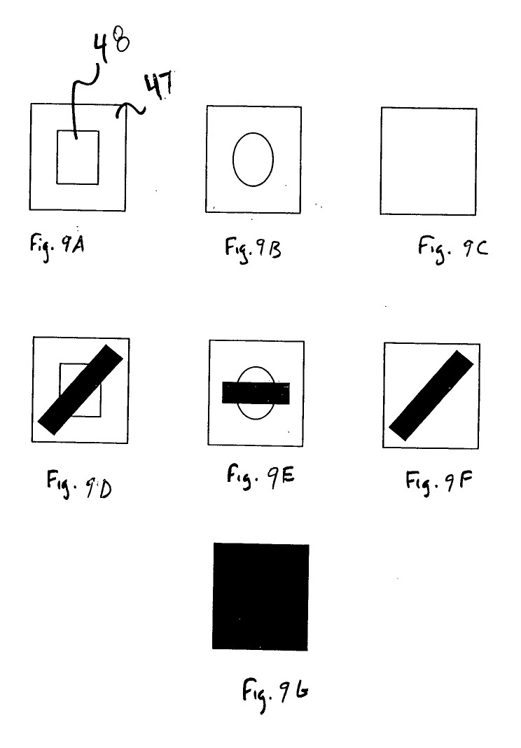

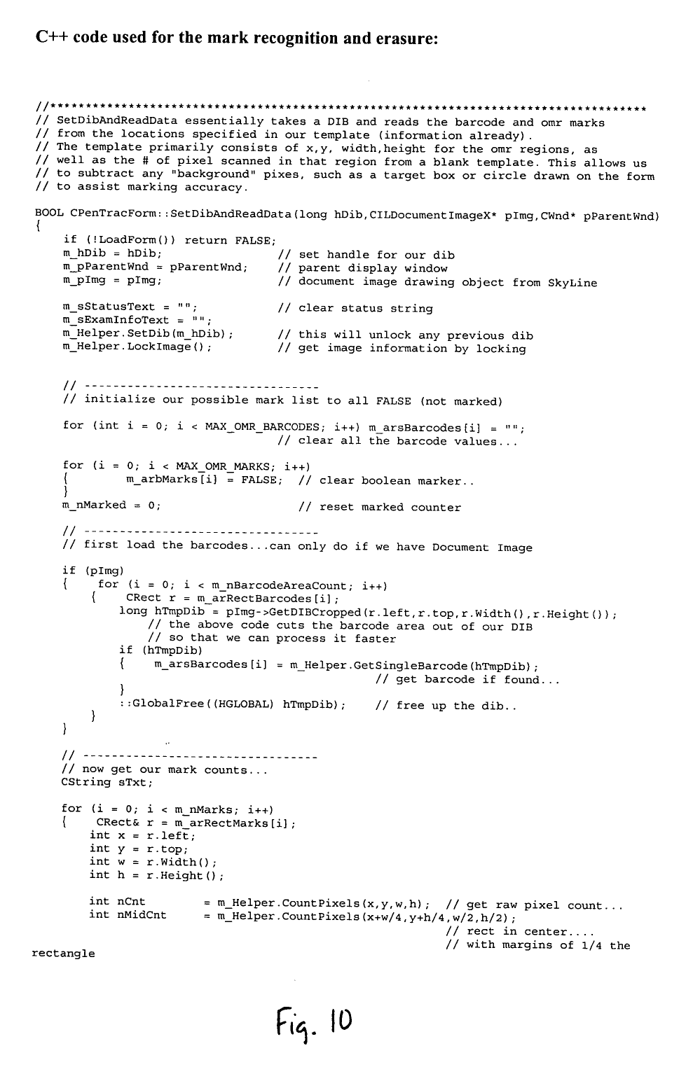

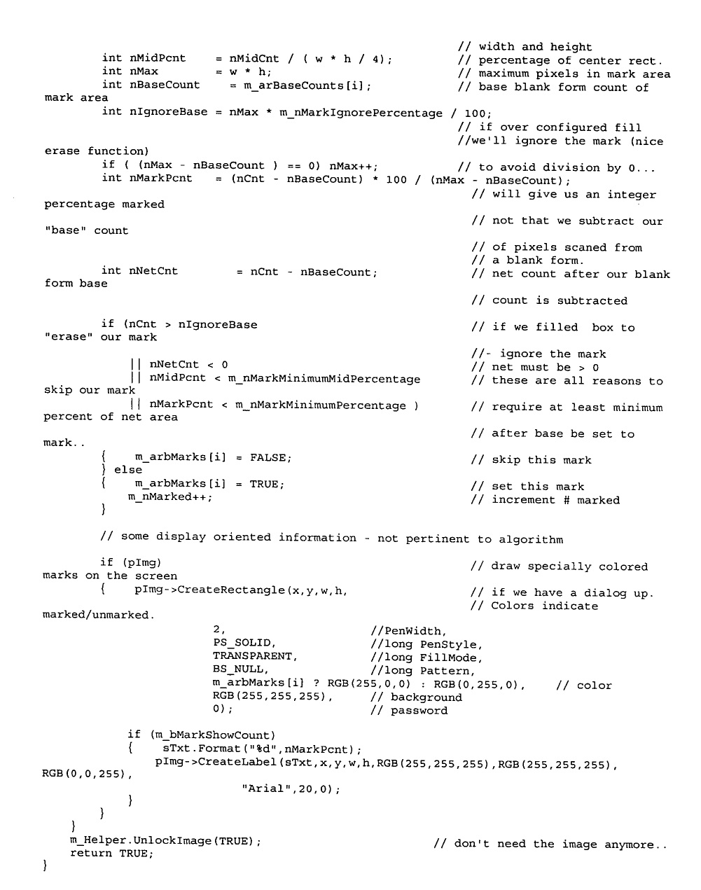

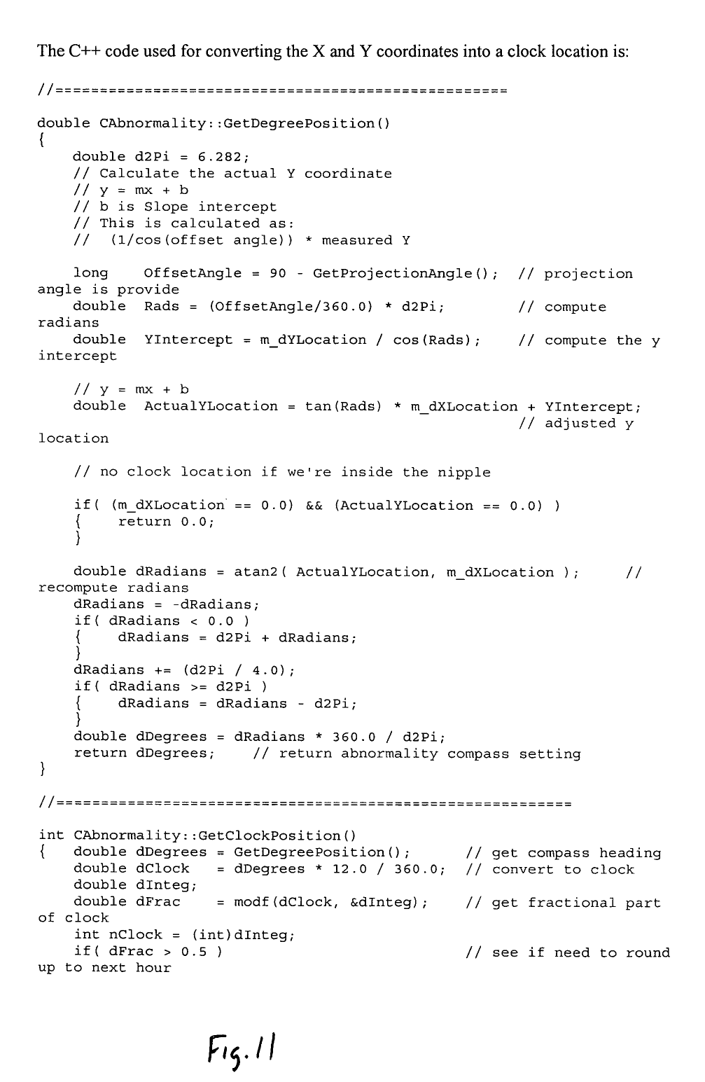

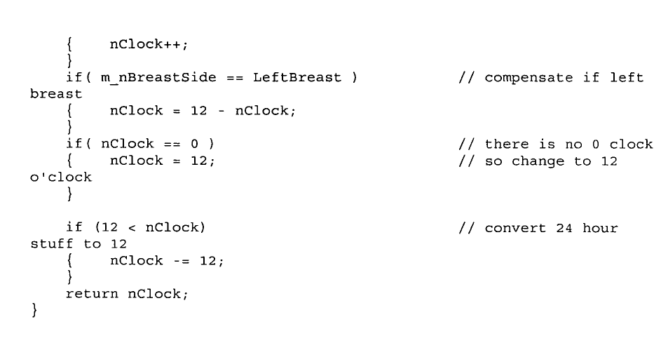

In another embodiment, illustrated in FIGS. 9A-9G, data form 40 may have an outer box 47 and inner bounded box 48 or, as illustrated in FIGS. 6 and 7, data form 40 may have Optical Marking Regions (OMR) 49 for marking. Data form 40 may be scanned into a scanning device to generate a baseline black pixel count for each mark bounding area 47 and 48 or a marking region 49. This information is stored in the medical information system 30. When a completed data form 40 is scanned and the black pixels are counted for each marking region 47, 48 and/or 49, the baseline black pixel count is subtracted prior to counting the pixels for the purpose of mark recognition. This allows the use of data forms 40 printed in black and white that may be printed on demand at a computer rather than using preprinted data forms with the mark regions outlined in colors that can be ignored. When a certain predefined percentage of black pixels are detected the selection is entered into system. However, if a user makes an error in selecting a particular box or region, the user may fill in the bounding area defined by the outer box to have system ignore the selection. An example of code used for marking and erasing marks is illustrated in FIG. 10 (which carries over onto the next page).

In another example embodiment, a method is provided for using Optical Mark Recognition (OMR) to provide software systems with the locations of breast abnormalities using single or dual breast image diagrams. When dual images representing two different dimensions are used, the system will automatically calculate the frontal clock position of the abnormality. The mammography images used may include mediolateral oblique views (MLO) and cranial caudal view (CC) view. These images may be either simple drawings, as illustrated in FIGS. 7 and 8, or actual film images printed on a sheet of paper, as illustrated in FIGS. 2-7. In either case, the radiologist may mark the OMR regions 49 to show the locations of abnormalities on a breast. Upon reading the positions of abnormality marks for each of these views, the software will use the projection angle of the MLO view and compute the appropriate frontal view clock location.

This method may use horizontal and vertical vectors of multiple, adjacent OMR marking regions 49 for determining locations. Each view has at least one such vertical and one horizontal mark vector. In the case of dual MLO with CC views, the images may be stacked one above the other, and/or have a single common horizontal OMR vector. Multiple OMR vectors are generally required to identify multiple abnormalities in a breast.

Referring to FIGS. 7 and 8, the vertical OMR vector on the MLO view provides the vertical location (coordinate y) of the abnormality while the vertical OMR vector on the CC view provides the horizontal location (coordinate x). The common horizontal OMR vector provides the depth (coordinate z). The x coordinate and y coordinate values are used to compute the frontal view clock location. The coordinate system on the MLO view assumes the z-axis (depth) is placed through the nipple so that the y-axis coordinates above the nipple are positive and below the nipple are negative. The CC view assumes the z-axis (depth) is placed through the nipple so that the x-axis (breast width) coordinates are either positive or negative above and below the z-axis depending upon if the CC view is of the left or right breast. Coordinates towards the center of the breast are preferably positive. An example code used for calculating the abnormality location is illustrated in FIG. 11 (which carries over onto the next page).

In use, a data form as described above for a particular patient is obtained and basic information, for example the current date and the patient's identification number, are noted on data form 40. After the patient has completed a medical imaging procedure, the CAD results of the medical images are transferred to data form 40 and a hard copy of the data form may be generated, for example by printing the data form from the CAD system. A radiologist may then mark his or her findings and recommendations either on or on a perimeter of the CAD results. If a hard copy is generated a radiologist may mark his or her findings directly on the hard copy data form 40. Findings and recommendations may include, but are not limited to, abnormalities noted, re-imaging requests, tissue type, follow-up procedures needed, recall interval, patient communication needed, and overall assessment status. The data form may also be configured to accommodate a range of diagnostic information 50 for reporting and tracking uses.

Referring back to FIGS. 6-8, the radiologist may also note the location of an abnormality by placing marks on the side and bottom of each image or drawing. When data form 40 is scanned, the marks will allow the software to calculate the clock location and depth of the abnormality using the x, y, and z coordinates. This will allow the radiologist to both authenticate CAD-placed prompts as either true or false and identify additional areas of interest that the CAD system may not have picked up.

After the radiologist has completed his or her notations on data form 40, the completed data form 40 is transferred to the medical information system 30 for tracking and archiving. Data form 40 may be transferred by scanning the hard copy into the medical information system 30 using Optical Mark Recognition (OMR) or Optical Character Recognition (OCR) technology. Alternatively, an administrative assistant may manually enter the results noted on the data form 40 into the medical information system 30. Additionally, depending on the selections indicated by the radiologist on data form 40, a complete narrative mammography report and any desired patient correspondence may be generated automatically, without requiring the radiologist to dictate the report or the correspondence.

The invention may be embodied in other specific forms without departing from the essential attributes thereof; therefore, the illustrated embodiments should be considered in all respects as illustrative and not restrictive. The claims provided herein are to ensure adequacy of the application for establishing foreign priority and for no other purpose.

What is claimed is:

1. A method of tracking abnormality data, comprising the steps of:
providing a data form having a visual result reporting area;
incorporating at least one mammography image from a computer aided detection system into the visual reporting area;
marking the data form to indicate an abnormality in the breast image; and
transferring the data form into a medical information system for reporting a diagnosis and tracking the abnormality.

2. The method of claim 1, wherein a physical copy of the data form is generated and is processed with optical recognition technology to determine the location of the abnormality.

3. The method of claim 1, further comprising providing a data form having a diagnostic information reporting area for receiving diagnostic information about a patient.

4. The method of claim 1, further comprising providing a data form having tracking information area for receiving personal history information about a patient.

5. The method of claim 1, wherein providing at least one breast image further includes:
providing a first mammography image adapted to receive a vertical mark and a horizontal mark;
providing a second mammography image adapted to receive a vertical mark and a horizontal mark; and
processing the first and second mammography images, wherein the vertical marking on the first mammography image provides a vertical location of the abnormality and the vertical marking on the second mammography image provides a horizontal location of the abnormality and the horizontal marking on the first and second mammography images provides a depth of the abnormality.

6. The method of claim 5, wherein a physical copy of the data form is generated and is processed with optical recognition technology to determine the location of the abnormality.

7. A method for tracking abnormality data, the system comprising:
a computer aided detection system adapted to capture at least one mammography image;
at least one data form adapted to receive a mammography image on a visual result reporting area of the data form and adapted to receive a mark on the data form to indicate an abnormality in the mammography image;
an arrangement for optically reading the data form; and
a medical information system adapted to receive the data form and to track information contained thereon.

8. The system of claim 6, wherein the computer aided detection system is adapted to detect an abnormality in the mammography image and to display a prompt on the mammography image of the data form.

9. The system of claim 8, wherein the medical information system is adapted to determine a clock location and depth of the abnormality using x, y and z coordinates created by an intersection of the markings of vertical and horizontal locations displayed on the mammography image.

10. The system of claim 8, wherein the data form is adapted to be scanned into the medical information system using optical mark recognition technology.

11. The system of claim 8, wherein the data form is adapted to be scanned into the medical information system using optical character recognition technology.

12 The system of claim 7, wherein the data form includes a diagnostic information reporting area for receiving a diagnosis.

13. The system of claim 7, wherein the data form includes a tracking area for receiving information about the patient.

14. A method of authenticating prompts placed by a computer assisted detection (CAD) system adapted to be associated with visual interpretation of more than two views by a radiologist, the method comprising the steps of:
generating mammography images from a CAD system;
providing at least one scannable data form adapted to receive at least two CAD mammography images, the mammography images being disposed on a visual information reporting area of the scannable data form; and
optically reading the data form; and
transferring the optically read data form to a medical information system for tracking of the data.

15. The method of claim 14, further comprising the step of capturing an area of interest not identified by CAD in one or two views of a mammography image.

16. The method of claim 14, wherein the at least one scannable data form includes a marking region, whereby the CAD system indicates a mark by detecting a number of black pixels in the marking region.

17. The method of claim 16, further comprising the step of automatically calculating a composite location, wherein a composite location is an abnormality noted in at least a pair of views of the same mammography image, based on marks placed on the scannable data form generated by CAD output, for three-dimensional representation for tracking.

18. The method of claim 16, further comprising the step of automatically calculating an abnormality location, not composite, based on marks placed on the scannable data form generated by CAD output, for two-dimensional representation for tracking.

19. The method of claim 16, wherein the at least one scannable data form includes an outer box and an inner box for marking, whereby the CAD system indicates a selection by detecting a predetermined number of black pixels in the inner box and indicates an erasure by detecting a predetermined number of pixels in the outer box.

20. The method of claim 16, wherein the mammography images include a mediolateral oblique mammography image and cranial caudal mammography image, wherein the vertical location of the abnormality is determined by a vertical OMR vector on the mediolateral oblique mammography image and the horizontal location of the abnormality is determined by a vertical OMR vector on the cranial caudal mammography image.

21. The method of claim 20, wherein the depth of the abnormality is determined from common horizontal OMR vectors on the mediolateral oblique and cranial caudal mammography images.
